(19) United States
(12) Patent Application Publication
(10) Pub. No.: US 2026/0008293 A1
(43) Pub. Date: Jan. 8, 2026

(54) Over Door Writing Surface System and Method of Use

(71) Applicant: Soroush Naji, London (GB)

(72) Inventor: Soroush Naji, London (GB)

(73) Assignee: Ornami Imports Limited, Slough (GB)

(21) Appl. No.: 18/764,282

(22) Filed: Jul. 4, 2024

(51) Int. Cl. B43L 1/00; A47B 97/00

(52) U.S. Cl. CPC B43L 1/00; A47B 97/001

(57) ABSTRACT

An over door writing surface system has hangers that attach to a writing surface such as a whiteboard and to the top of a door. The hanger has two channels attached together, a door channel and a frame channel. The door channel is U-shaped and sized to accommodate the width of a door. The frame channel is tubular with an opening the length of the tube that allows the frame of the writing surface to enter and attach to it.

### BACKGROUND

The invention relates generally to whiteboard systems and more specifically to an over door writing surface system that attaches to a writing surface such as a whiteboard and allows it to hand over the top edge of a door so that the writing surface is suspended over the large surface of a door.

Common whiteboard systems are used to temporarily write or draw on to communicate with groups of people. Commonly, these whiteboards are attached to walls by fasteners, adhesives, or similar mounting methods. They can cover a large portion of the wall. When not in use these whiteboards create dead or wasted space on the wall.

Several manufacturers have developed alternative mounting methods. Some of these mounting methods are functional to a point but must be considered at the time of installation or purchase of the whiteboard. If alternative mounting options are desired after purchase no solutions exist to accommodate the existing whiteboard.

One of the problems associated with common whiteboard systems is their limited use. For example, the permanent attachment of a whiteboard to a wall does not accommodate limited spaces where walls are not available to mount a whiteboard to. Additionally, if the whiteboard is needed for a short term, it becomes a waste when not in use.

While developments have been made in the area of common whiteboard systems room exists for further improvement.

### SUMMARY OF THE INVENTION

The system of the application discloses a removable hanger both attaches to a writing surface and a door to suspend the writing surface such a s whiteboard to a door. When the writing surface is suspended in this way it takes advantage of the space on the back or front of the door. It also allows for the placement and removal of the writing surface so that when it is needed it is placed on a door and when it is not needed it is removed and stored. The hangers attach to a unique whiteboard frame and thereby ensures a correct fit and function when in use.

### DESCRIPTION OF THE DRAWINGS

The figures include like indicators that represent the same part or feature from one figure to another. The intent of the figures is to illustrate the concepts of the invention and not to limit or restrict the scope of the disclosure.

FIG. 1 is a side view of an over door writing surface system in accordance with the preferred embodiment of the invention;

FIG. 2 is a side view of the hanger of FIG. 1;

FIG. 3a and FIG. 3b are perspective views of the system of FIG. 1 in use,

FIG. 4 is a flowchart of a method of attaching a writing surface to a door; and

FIG. 5 is a diagram of alternative embodiments of the writing surface of FIG. 1.

### DESCRIPTION OF THE IDEA

The present invention is described herein to provide insight and knowledge of the idea and the benefits it provides. Aspects of the idea will provide additional benefit to those skilled in the art and should be respected as intellectual property of the inventor. While changes and modifications to the described idea are natural in the development process it is anticipated that these changes will not alter or diminish the scope of the invention.

It is believed that the idea of this disclosure solves one or more problems associated with common whiteboard systems. Namely, the invention allows for a whiteboard or another writing surface to be attached at will to the back or front of door. The invention is modular and is installed or removed as the need for the writing surface changes. It is believed that benefits from the idea described herein are not limited to those that have been expressly described but will be understood by those skilled in the art of whiteboard systems.

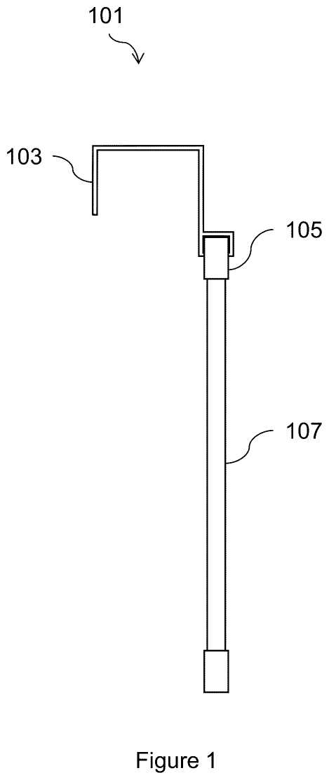

Referring now to the figures of the application the idea will be described in its detail components. It will be understood that like numbers in the various figures are indicative of the same part or piece in multiple figures. FIG. 1 depicts a side view of an over door writing system in its preferred embodiment. It will be understood that system 101 provides improvements over common whiteboard systems.

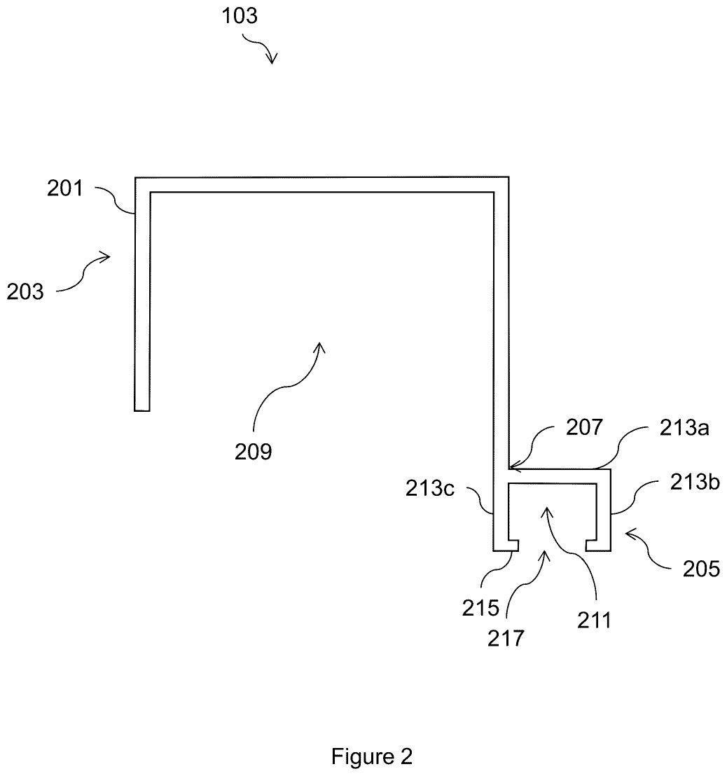

The preferred embodiment of system 101 includes hangers 103 that slidingly attach to the upper frame 105 of a writing surface 107. Referring to FIG. 2, hangers 103 include a body 201 that has a door channel 203 and a frame channel 205. Door channel 203 and frame channel 205 are fixedly attached along a shared exterior edge 207 of door channel 203. Door channel 203 is generally U-shaped and sized so that the top of a door fits within the interstitial space 209 thereof. Frame channel 205 has a hollow space 211 bounded by three solid sides walls 213 and an access wall 215 that is joined at two ends to two opposing side walls 213 and has an opening 217 therein so that hollow space 211 is open to receive upper frame 105 of writing surface 107.

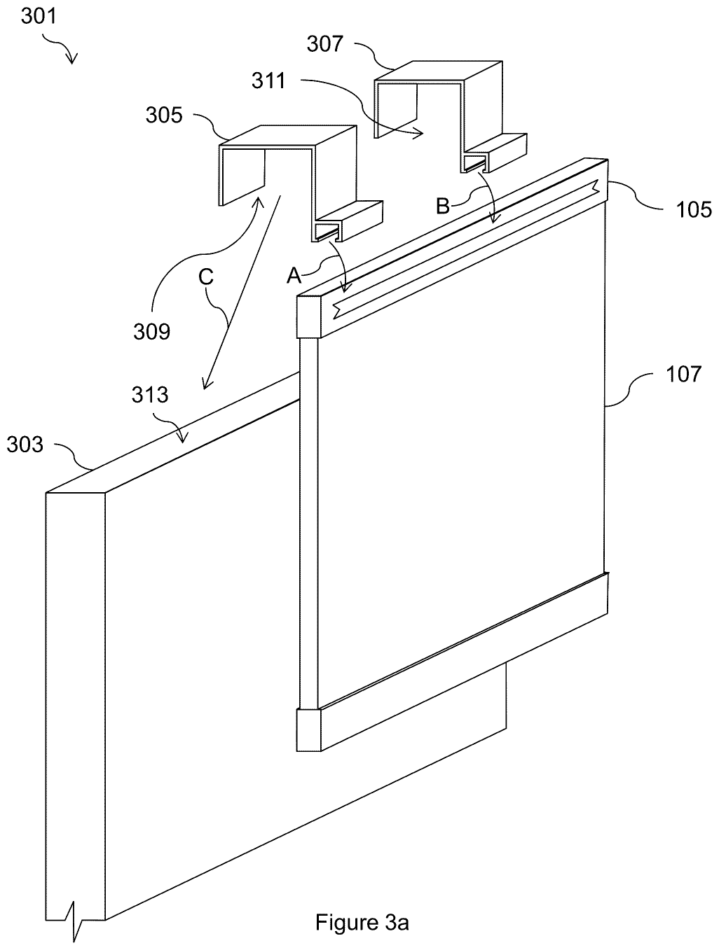

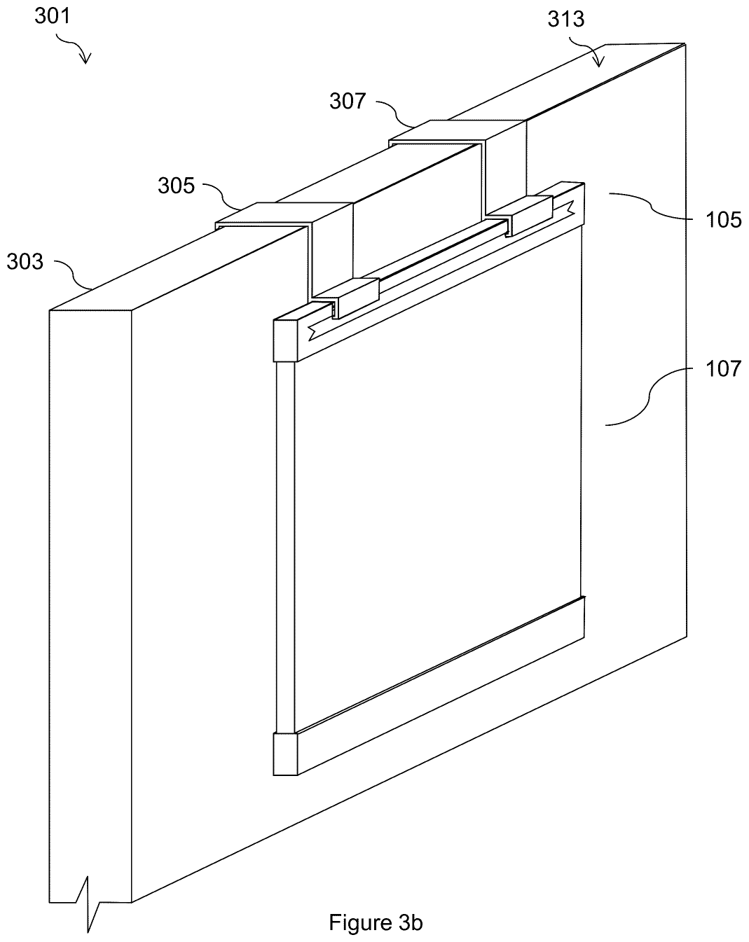

In use, and referring to FIGS. 3a and 3b, the number of hangers 103 is determined by the size and weight of writing surface 107 and the size and shape of a door 303 to which writing surface 107 is to be mounted. In the present embodiment 301, a first hanger 305 and a second hanger 307 are slidingly attached to upper frame 105 of writing surface 107 as depicted by motions A and B respectively. Once attached, door channels 309 and 311 of first hanger 305 and second hanger 307 respectively are positioned so that the upper edge 313 of door 303 rests therein as depicted by motion C. Writing surface 107 rests on first hanger 303, second hanger 305 and the surface 309 of door 303.

One unique feature of the invention is that hangers 103 attach to writing surface frames. Hangers 103 also enable the rapid and temporary attachment of writing surface 107 via door channel 203.

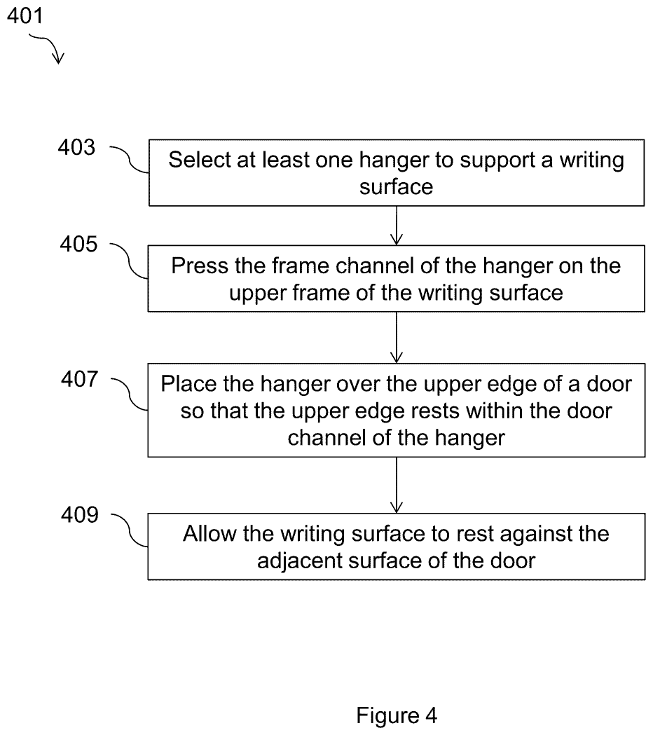

Referring now to FIG. 4, a method of attaching a writing surface to a door is depicted. Method 401 includes selecting at least one hanger to support a writing surface 403, pressing the frame channel of the hanger on the upper frame of the writing surface 405, placing the hanger over the upper edge of a door so that the upper edge rests within the door channel of the hanger 407, and allowing the writing surface to rest against the adjacent surface of the door 409.

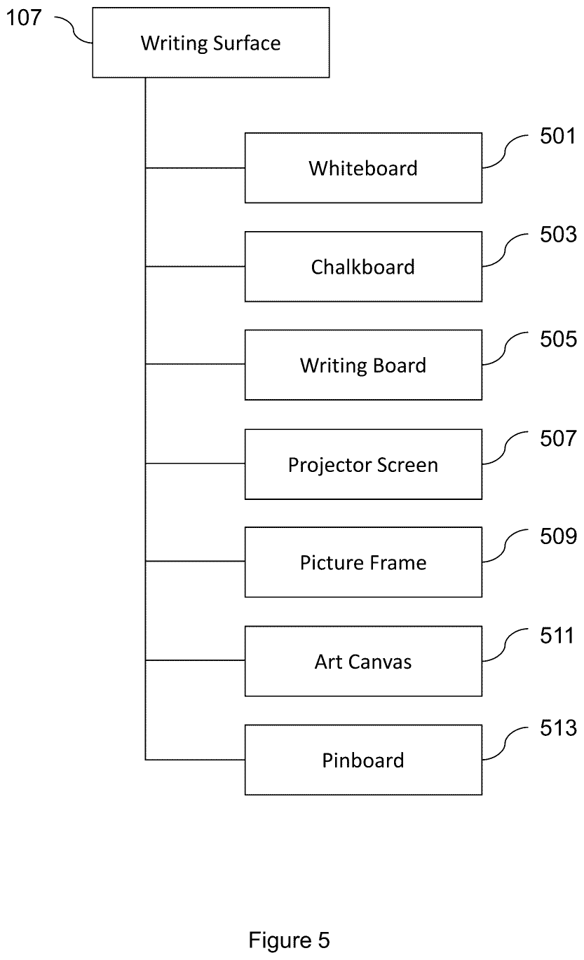

It is contemplated and will be appreciated that writing surface 107 will take on different forms without deviating from the intent of this disclosure. For example, and referring to FIG. 5, writing surface 107 could be a whiteboard 501 that is able to have dry erase marker leave ink thereon. Further, writing surface 107 could be a chalkboard 503, writing board 505 or a projector screen 507 that would allow for digital writing thereon. It will be understood that whiteboard 501 has a similar appearance to projector screen 507 but without the explicit ability to write thereon. Additionally, other forms that allow for the display and marking while suspended from a door could include a picture frame 509, an art canvas 511, or a pinboard 513, where paper or other material is attached and written on.

The concepts and principles described above are not meant to limit the scope of the invention or its manner of implementation. The concepts and principles of the idea are intended to be protected in part and in whole.

What is claimed:

1. An over door writing surface system, comprising;
at least one hanger slidingly attached to the upper frame of a writing surface;
the hanger includes a body with a door channel and a frame channel integral thereto and fixedly attached along a shared exterior edge;
the door channel includes a u-shape that forms an interstitial space therein;
the frame channel includes three solid walls and an access wall that is joined at two ends to the adjacent opposing side walls, the access wall has an opening therein that passes therethrough to a hollow space that is bounded within the three solid walls and the access wall;
wherein the upper frame of a writing surface slides into the hollow space of the frame channel of the hanger; and
wherein the upper edge of a door enters the door channel of the hanger and thereby suspends the writing surface on the door.

2. A method of attaching a writing surface to a door, comprising:
selecting at least one hanger to support a writing surface;
pressing the frame channel of the hanger on the upper frame of the writing surface;
placing the hanger over the upper edge of a door so that the upper edge rests within the door channel of the hanger; and
allowing the writing surface to rest against the adjacent surface of the door.
